(19) United States
(12) Patent Application Publication
(10) Pub. No.: US 2016/0072317 A1
(43) Pub. Date: Mar. 10, 2016

(54) METHOD AND SYSTEM FOR POWER PROVISIONING

(71) Applicant: Avogy, Inc., San Jose, CA (US)

(72) Inventors: Mikhail Guz, San Jose, CA (US); Antoin Russell, San Jose, CA (US)

(21) Appl. No.: 14/479,855

(22) Filed: Sep. 8, 2014

(51) Int. Cl. H02J 7/00; H02J 1/14

(52) U.S. Cl. CPC H02J 7/0021; H02J 7/007; H02J 7/0052; H02J 1/14; H02J 2007/0062

(57) ABSTRACT

A method of operating a power adapter having multiple outputs includes setting an output priority for each of the multiple outputs and providing an output voltage at each of the multiple outputs. The method also includes measuring one or more operating parameters of the power adapter and determining that at least one of the one or more operating parameters are greater than a setpoint. The method further includes reducing the output voltage associated with at least one of the multiple output ports.

### BACKGROUND OF THE INVENTION

Mobile electronic devices, such as portable computers, tablets, smartphones, electronic book readers, and the like, are becoming increasingly popular. These mobile devices are typically powered by batteries. Power adapters (e.g., alternating current (AC) power adapters) are typically provided in conjunction with mobile electronic devices so that the mobile devices can be powered by or recharged using an electrical outlet.

Despite the progress made in power adapters for mobile devices, there is a need in the art for improved methods and systems related to power supplies.

### SUMMARY OF THE INVENTION

The present invention relates generally to electronic devices. Embodiments of the present invention relate to a mobile application (also referred to as an app) that interacts with a power adapter. In a particular embodiment, power provisioning and control of the power adapter are provided through the mobile application. Without limiting embodiments of the present invention, the mobile application described herein provides for setup, management, and performance monitoring of a power adapter having multiple outputs (e.g., three output ports), also referred to as a multiple port power adapter. The power adapter is useful for powering and charging of multiple electronic devices concurrently. The present invention is applicable to a broad range of power adapters, including single output power adapters as well as multiple output power adapters.

Embodiments of the present invention relate to a mobile application that enables users to perform configuration of the multiple output port power adapter and monitoring of the charging processes. As described herein, the configuration process includes defining prioritization of the charging of devices connected to the power adapter. Merely by way of example, since the multiple output power adapter has a maximum power output value, it is possible that the sum of the loads associated with the devices connected to the power adapter could exceed the maximum power output value (also referred to as a power rating). To address this issue, prioritization of the charging processes enables charging of multiple devices such that the power rating is not exceeded.

According to an embodiment of the present invention, a method of prioritizing powering processes is provided. The method includes establishing a communications channel between a control device and a power adapter having a power rating and a plurality of output ports. A first output port of the plurality of output ports has a first maximum power level and is operable to power a first electronic device and a second output port of the plurality of output ports has a second maximum power level and is operable to power a second electronic device. The method also includes presenting, to a user, a list of electronic devices including the first electronic device and the second electronic device and defining a prioritization for powering of the first electronic device and the second electronic device. The prioritization ranks the first electronic device higher than the second electronic device. The method further includes providing a first output power at the first output port operable to power the first electronic device, determining that concurrent powering of the second electronic device will exceed the power rating of the power adapter, and providing a second output power at the second output port less than the second maximum power level.

According to another embodiment of the present invention, a method of monitoring one or more charging processes is provided. The method includes establishing a communications channel between a control device and a power adapter having a first output port and defining a relationship between a first electronic device and the first output port. The method also includes displaying, in a graphical user interface, a status of the first electronic device.

According to a specific embodiment of the present invention, a method of displaying charging priorities for a plurality of electronic devices is provided. The method includes establishing a communications channel between a control device and a power adapter having multiple output ports and associating a first priority with a first electronic device having a first charging profile. The method also includes associating a second priority with a second electronic device having a second charging profile and displaying, in a graphical user interface, a charging priorities table including the first priority, a reference to the first electronic device, the second priority, and a reference to the second electronic device.

According to another specific embodiment of the present invention, a method of displaying charging thresholds for a plurality of electronic devices is provided. The method includes establishing a communications channel between a control device and a power adapter having multiple output ports and defining a first charging threshold for a first electronic device having a first charging priority. The method also includes defining a second charging threshold for a second electronic device having a second charging priority. The method further includes displaying, in a graphical user interface, a charging priorities table including the first charging priority, a reference to the first electronic device, and the first charging threshold and the second charging priority, a reference to the second electronic device, and the second charging threshold. Additionally, the method includes charging the first electronic device at a first charging rate.

According to a particular embodiment of the present invention, a method of operating a power adapter having multiple outputs is provided. The method includes setting an output priority for each of the multiple outputs and providing an output voltage at each of the multiple outputs. The method also includes measuring one or more operating parameters of the power adapter and determining that at least one of the one or more operating parameters are greater than a setpoint. The method further includes reducing the output voltage associated with at least one of the multiple output ports.

Numerous benefits are achieved by way of the present invention over conventional techniques. For example, embodiments of the present invention provide a user with the ability to charge multiple devices concurrently or simultaneously even though the combined power requirements of the devices being charged exceeds the power rating of the power adapter, accelerate the charging process, charge more important devices faster than others, and reduce energy consumption. These and other embodiments of the present invention, along with many of its advantages and features, are described in more detail in conjunction with the text below and attached figures.

### BRIEF DESCRIPTION OF THE DRAWINGS

FIG. 1 is a simplified schematic diagram illustrating interaction between a mobile application and a power adapter according to an embodiment of the present invention.

FIG. 2 is perspective diagram of a variable output power supply and a power cable suitable for use with embodiments of the present invention.

FIG. 3 is a simplified graphical user interface illustrating system settings according to an embodiment of the present invention.

FIG. 4 is a simplified graphical user interface illustrating system priority settings according to an embodiment of the present invention.

FIG. 5A is a simplified graphical user interface after setting charging priority according to an embodiment of the present invention.

FIG. 5B is a simplified graphical user interface illustrating charging priority and charging thresholds according to an embodiment of the present invention.

FIG. 6 is a simplified graphical user interface illustrating scheduling of charging according to an embodiment of the present invention.

FIG. 7 is a simplified graphical user interface illustrating scheduling charge start time according to an embodiment of the present invention.

FIG. 8 is a simplified graphical user interface illustrating monitoring of device charging according to an embodiment of the present invention.

FIG. 9 is a simplified graphical user interface illustrating LED operation according to an embodiment of the present invention.

FIG. 10 is a simplified graphical user interface illustrating scheduling of LED operation according to an embodiment of the present invention.

FIG. 11 is a simplified graphical user interface illustrating scheduling of LED extinguishing according to an embodiment of the present invention.

FIG. 12 is a simplified flowchart illustrating a method of operating a power adapter having multiple outputs according to an embodiment of the present invention.

### DETAILED DESCRIPTION OF SPECIFIC EMBODIMENTS

The present invention relates generally to electronic devices. More specifically, the present invention relates to a mobile application (also referred to as an app) that interacts with a power adapter. In a particular embodiment, power management and control of the power adapter are provided through the mobile application. Without limiting embodiments of the present invention, the mobile application described herein provides for setup, management, and performance monitoring of a power adapter having multiple outputs (e.g., three outputs). The present invention is applicable to a broad range of power adapters, including single output power adapters as well as multiple output power adapters.

Embodiments of the present invention can be utilized with a variety of mobile devices, including mobile devices compatible with both iOS as well as Android, although other operating systems, including Blackberry, Windows Phone 8, Symbian, and the like are included within the scope of the present invention. Thus, mobile devices suitable for use with the present invention include mobile phones, tablets, e-readers, game consoles, portable (e.g., laptop) computers, and the like. Moreover, embodiments of the present invention provide for integration with social media sites 134, including Facebook, Twitter, and the like.

In addition to interaction with power adapter, the mobile application is able to receive push notifications from external sources, such as a website related to the power adapter. These push notifications can include information on new products, accessories, product promotions, and the like. Additionally, software updates can be delivered to the mobile application for further delivery to the power adapter. One of ordinary skill in the art would recognize many variations, modifications, and alternatives.

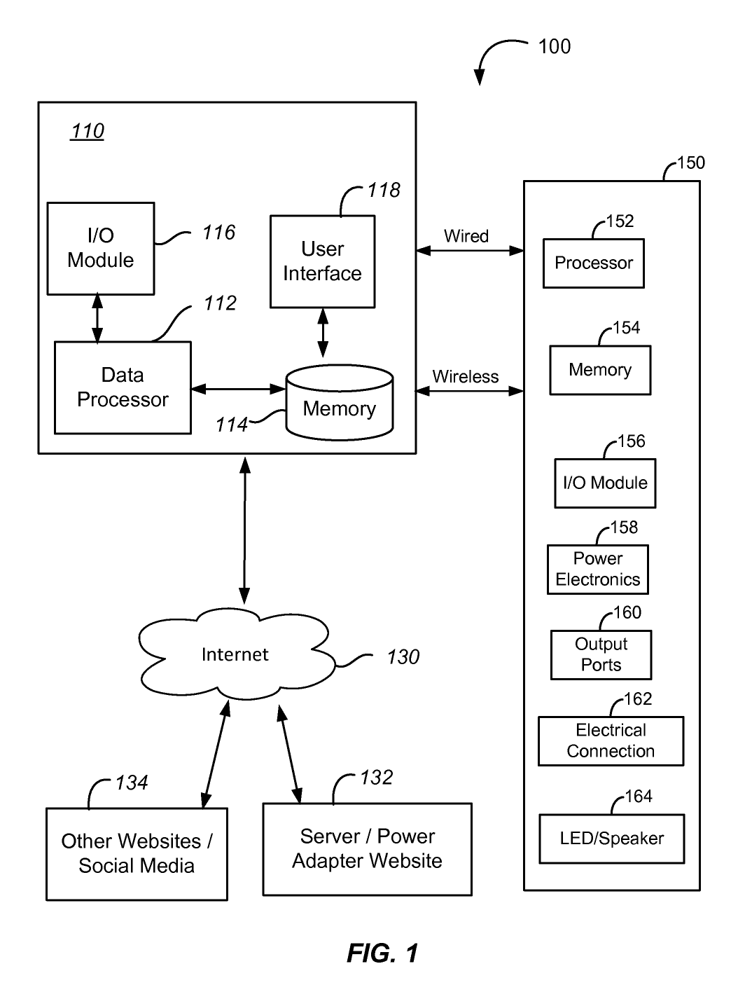

As illustrated in FIG. 1, the mobile device 110 includes an input/output module 116 that is operable to communicate with server 132 through the internet 130. Interacting with server 132, the mobile application enables the user to interact with various external programs such as a tip configurator used to specify the proper tip to be used with a particular laptop computer, perform device selection, and provide access to user manuals that are available through on-line sources. As illustrated in FIG. 1, the input/output module 116 can detect the presence of an internet connection and display the presence or absence of the internet connection through the display 116. As an example, if no Internet connection is detected by the I/O module, an appropriate user notification can be displayed through the display, through an audio output, or the like.

The display 116 is able to support a series of graphical user interfaces (GUIs) that are utilized to receive and communicate information related to the power adapter.

Memory 114 is operable to store data related to the power adapter, including default configuration settings, the latest user-defined configuration settings, historical configuration settings, power consumption information, or the like. Other functionality provided by the mobile device, for example, calendar and clock functionality, can be utilized by and in conjunction with the mobile application interacting with the power adapter. For example, the integration with Calendar and Clock functionality on the mobile device enables the mobile application to perform scheduling functions and synchronization of LED operations with the clock or alarm.

The power adapter 150 includes a processor 152 and a memory 154. The processor is used to process data related to the devices connected to the power adapter as well as data related to power adapter performance as described more fully herein. An I/O module 156 is provided to interact with the I/O module 116 in the control device 110. Using the I/O module 156, the power adapter 150 can interact with the control device 110 through either wired (e.g., USB) or wireless (e.g., Bluetooth) connections. Power electronics 158 provide power to one or more output ports 160. In some embodiments, the power adapter 150 includes a plurality of output ports, with some output ports operable to provide a higher output power level than other of the output ports. In a particular embodiment, a laptop computer can be connected to one of the output ports that provides a suitable output power appropriate to power or charge a laptop computer.

The power adapter 150 also includes an electrical connection 162, for example, electrical prongs, that enable the power adapter to be plugged into a supply of electrical power. In some embodiments, the power adapter can include a battery to supplement the power provided through the electrical connection 162. Indicators in the form of an LED and/or a speaker can be provided to provide for feedback from the power adapter and monitoring of the power adapter.

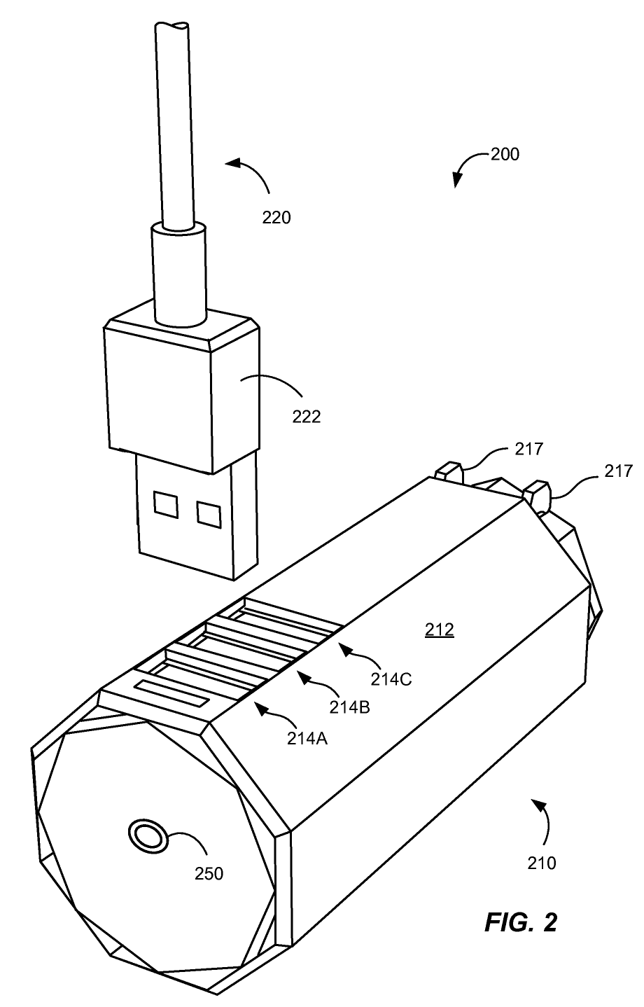

FIG. 2 is perspective diagram of a variable output power adapter and a communications cable suitable for use with embodiments of the present invention. It should be noted that the communications cable is operable to carry both communications and power. As illustrated in FIG. 2, the variable output power adapter 210 can be connected to communications cable 220, which in turn, is connected to a mobile device (not shown). Additional description related to the power adapter 210 is provided in commonly assigned U.S. patent application Ser. No. 14/301,046, filed on Jun. 10, 2014, entitled “Method and System for a Variable Output Power Supply,” the disclosure of which is hereby incorporated by reference for all purposes. The power adapter 210 includes a housing 212 and a plurality of output ports 214A, 214B, and 214C, also referred to as output connections. In the illustrated embodiment, there are three output ports, but this is not required by embodiments of the present invention and other number of output ports, including two, four, five, six, or more, can be provided. Embodiments of the present invention are applicable to a variety of power adapters and the mobile application supports the three output port power adapter illustrated in FIG. 2 as well as other power adapters as described herein.

As described in the application referenced above, the plurality of output ports 214A, 214B, and 214C differ, with one or more of the output ports providing a variable voltage output depending on the type of cable connected to the output connection. In some embodiments, one of the plurality of output ports, for example, output port 214A is operable to output multiple voltages depending on the configuration or type of the cable and is thus referred to as a variable voltage output port. As an example, the output port 214A can operate as a standard 5 V compliant USB port when a standard USB cable is connected. However, when a special cable is connected, the operation of the output port 214A is modified to operate at a higher voltage (e.g., 19.5 V), which is suitable for charging a laptop computer. Thus, the output port 214A is variable depending on the cable that is connected, providing functionality not available using conventional designs.

It should be noted that in the embodiment illustrated in FIG. 2, a USB cable with USB connector 222 is utilized as the communications cable 220 that provides both communications and power. However, this is not required by the present invention and other connector designs can be utilized including standardized and proprietary connector designs, including plugs, receptacles, and terminal blocks. One of ordinary skill in the art would recognize many variations, modifications, and alternatives.

Referring to FIG. 2, the communications cable 220 has a USB connector 222 that can be inserted into the ports of the power adapter. As described more fully herein, connection of the communications between the power adapter and the mobile device enables communication between the mobile device and the power adapter, for example, in the context of the mobile application described herein.

In addition to communication between the mobile device 110 and the power adapter 150 through a wired connection as illustrated in FIG. 2 (e.g., a USB connection), wireless connections can be established to complement or supplement a wired connection. Examples of wireless connections include Bluetooth connections and the like.

The power adapter 210 also includes an LED 250 or other light emitting device that is positioned on housing 212. The LED is utilized to provide information on the status of the power adapter as well as other functions as described herein. The LED can be a single color LED or a variable color LED depending on the application. Although the LED 250 is illustrated on an end of the housing 212, this is not required the position of the LED, the number of LEDs, and the like can be modified to meet the particular system objectives.

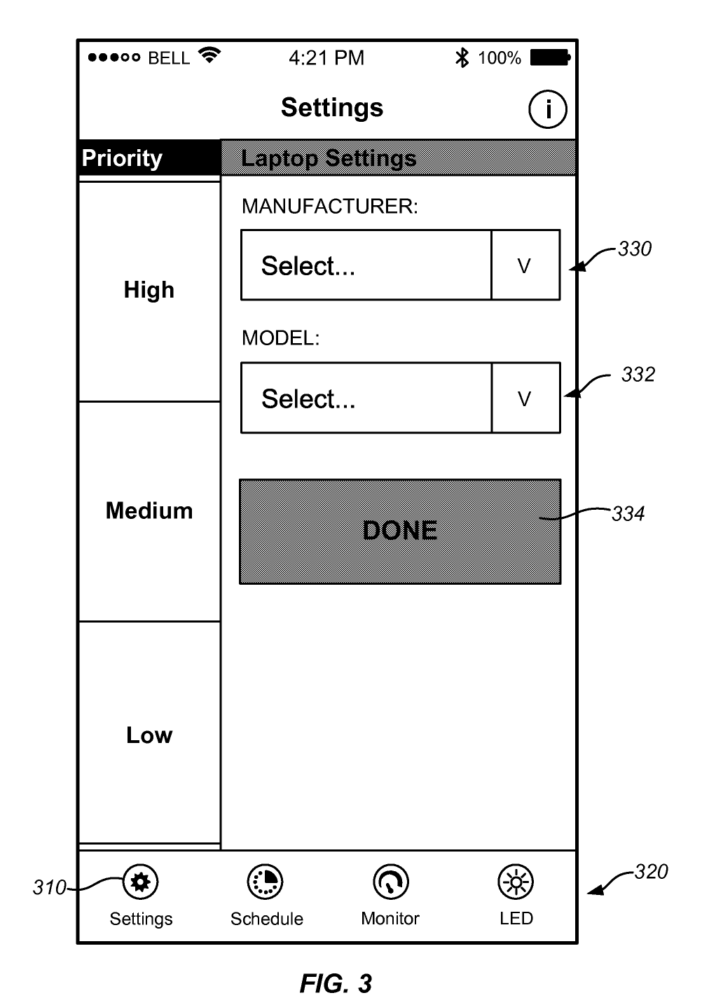

FIG. 3 is a simplified graphical user interface illustrating system settings according to an embodiment of the present invention. Referring to FIG. 3, system settings are accessible through selection of the Settings icon 310 in the icon tray 320 disposed at the lower portion of the graphical user interface in this embodiment. The Settings icon 310 is modified to become brighter, change color, or the like when the Settings icon is selected. One of ordinary skill in the art would recognize many variations, modifications, and alternatives. The graphical user interface illustrated in FIG. 3 enables a user to select a manufacturer and model number of devices that will be associated with differing charging priorities as described more fully herein.

According to embodiments of the present invention, the mobile application provides a variety of functions related to the power adapter. Initially, a communications connection is established between the mobile application and the power adapter. As illustrated in FIGS. 1 and 2 and discussed above, the communications connection can be through a wired connection, for example, a USB cable, or through a wireless connection, such as Bluetooth. After establishing a connection between the mobile device and the power adapter, a configuration process can be performed to customize the power adapter to the particular electronic devices that that user desires to use with the power adapter.

After communication is established, the mobile application will read the firmware and hardware model versions of the power adapter from registers in the power adapter. This information enables the mobile application to tailor the functionality and subsequent screens to the specific power adapter model that is being utilized. In addition, the mobile application will read power adapter settings from registers containing configuration settings and compare them to the configuration settings stored in the memory of the mobile device. In an implementation, the configuration settings stored in the memory are the settings that were used by the mobile application during its last time being operated. In case the configuration settings in the power adapter and settings stored by in the mobile application are different, the mobile application can display a message advising the user that the settings are different and providing the user with an opportunity to select the settings that are desired. In another embodiment, the user can confirm that it is acceptable to apply the settings that are stored by the mobile application. One of ordinary skill in the art would recognize many variations, modifications, and alternatives.

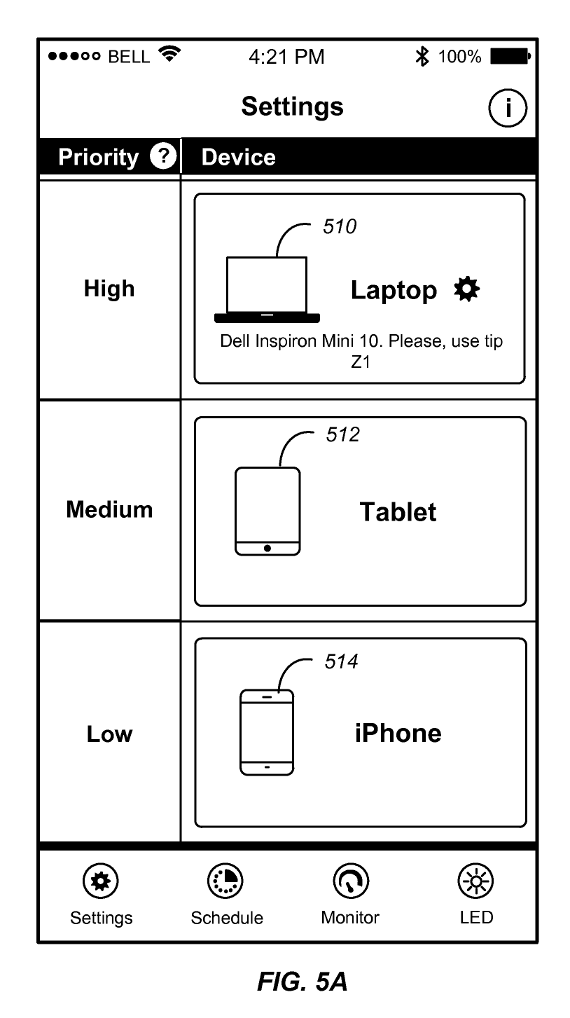

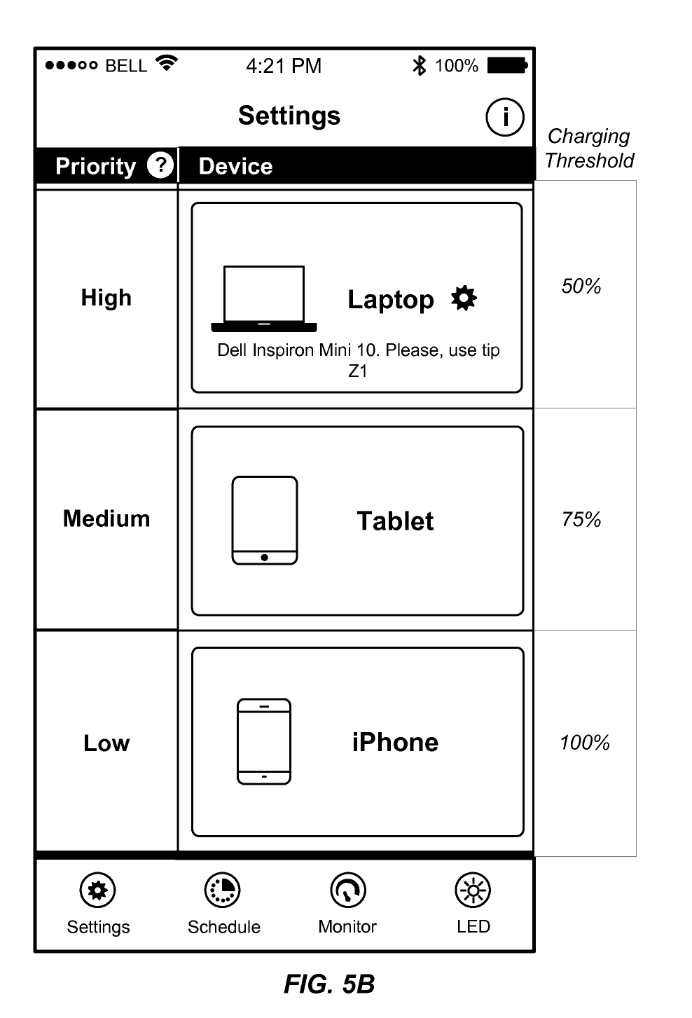

Referring once again to FIG. 3, the Settings graphical user interface enables the user to select a laptop manufacturer's name and the laptop model from a configuration menu associated with the output port for the laptop. Manufacturer selection area 330 and model selection area 332 are illustrated in FIG. 3 and allow the user to select the laptop settings, i.e., manufacturer and model. A list of manufacturers and particular models for the selected manufacturer can be provided through a drop down list or through other suitable means. After selecting a manufacturer and a model, the user selects the DONE button 334 to proceed to the next phase of the setup process. In response to the user selections, the mobile application is able to display the part number of other identifier for the laptop tip as illustrated in FIG. 5A and record the laptop configuration information in memory. In addition to manufacturer and model number, other information related to the laptop, including model-specific information such as the model identification code (CONFIGLAP), maximum output voltage (VOUTMAX), maximum output current (IOUTOCP), pulse width modulation duty cycle data (PWMDUTY), an EEPROM ID for the laptop (EPROMID), tip identifier (Tip), and the like can be recorded in memory. As will be evident to one of skill in the art, some laptop charging cables include, not only positive and ground for electrical charging, but a third or other additional wire that can be used to communicate configuration or identification information. Some embodiments of the present invention can utilize charging cables that include the third wire to read or provide configuration information, such as the EEPROM ID to ensure compatibility.

Table 1 is an exemplary lookup table containing laptop configuration information. The data in Table 1 is provided to illustrate configuration information for a default laptop and an HP laptop. This table is not intended to limit the information that can be obtained and stored, but is merely provided by way of example.

TABLE 1

| Mfg | Model | CONFIGLAP | VOUTMAX | IOUTOCP | PWMDUTY | EPROMID | Tip |
|---|---|---|---|---|---|---|---|
| Default | Default | 00 | 19.5 | 4.0 | 50 | 00 | |
| HP | Envy 4 | 10 | 19.5 | 3 | 50 | 10 | Z7 |

In an embodiment, during the process of selecting the manufacturer and model of a device, the power or charging cable utilizes an additional wire (e.g., the third wire) to communicate the proper identification code to the device, which thereby identifies the power adapter as an OEM power adapter for the particular device. In an embodiment, this process can be automated such that when the graphical user interface illustrated in FIG. 3 is used to set the manufacturer and model, the configuration information is then provided to the device to enable operation in native mode.

In the absence of a user's input for the laptop configuration, a default set of configuration settings can be used. This configuration is illustrated in Table 1 as the Default model. If, during the configuration process, the user is not able to find a specific laptop model in the lists provided through the manufacturer selection area 330 and model selection area 332, the a message can be displayed to the user in the Settings graphical user interface to advise the user to update the mobile application. Updating of the mobile application to the latest version will provide the user with additional options for the laptop listings. If the mobile application is running the current version, then a message can be displayed to the user in order to inform the user that a default or predetermined set of values are being utilized.

It should be noted that if communication cannot be established between the mobile device and the power adapter, then a message prompting the user to check cable connections can be displayed.

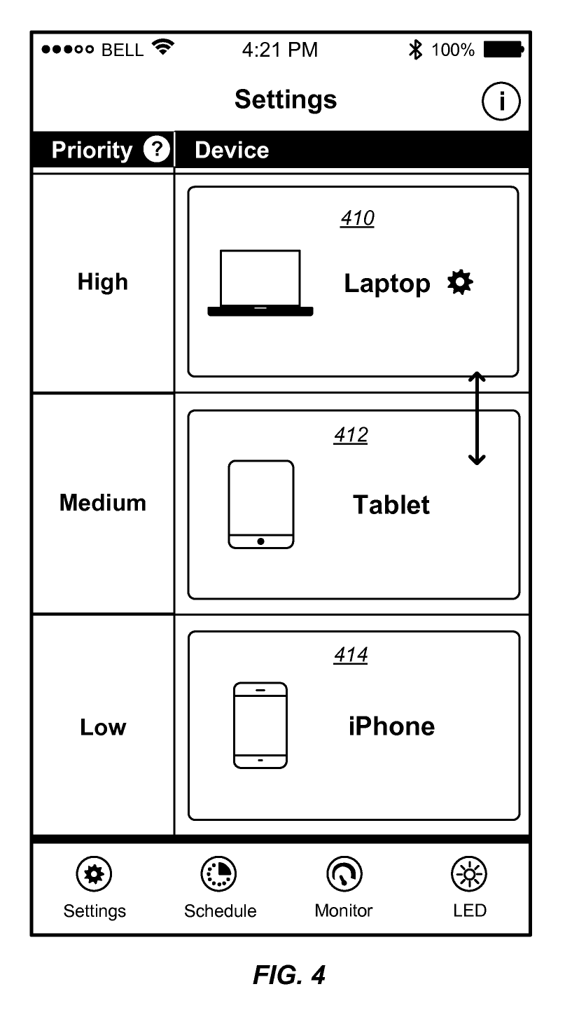

FIG. 4 is a simplified graphical user interface illustrating system priority settings according to an embodiment of the present invention. In this Settings graphical user interface, charging priority is listed in a left hand column and devices that can be operated or charged using the power adapter are listed in a right hand column. The right hand column includes a plurality of tiles 410, 412, and 414 that include icons associated with particular devices.

As illustrated in FIG. 4, since the power adapter has multiple output ports, the mobile application is useful in setting the charging priority for the various output ports. In an embodiment, default priorities are defined by settings that are stored in a register in the power adapter, a register in the memory of the mobile device, or the like. By default, in some implementations, the charging priority is set to laptop, then tablet, then phone (e.g., a smartphone) as illustrated in FIG. 4, in which the laptop has a high priority, the tablet has a medium priority, and the phone has a low priority. These priorities are shown to the user by moving or dragging the tile for each device to a position adjacent the desired charging priority. In the illustrated embodiment, the priorities are fixed and the tiles are movable, but the present invention is not limited to this implementation and in other embodiments, the priorities are movable or both the priorities and tiles are movable. One of ordinary skill in the art would recognize many variations, modifications, and alternatives.

Embodiments of the present invention enable a user to modify the charging priority. In FIG. 4, the vertical arrow displayed between the tiles including the laptop and table device icons illustrates the ability of the user to modify the default priorities and to set different priorities between the output ports of the power adapter (e.g., the Laptop, Tablet, and Phone output ports). When a user selects priorities High (e.g., Priority 1) and Medium (e.g., Priority 2), the remaining output can be automatically set to priority Low (e.g., Priority 3).

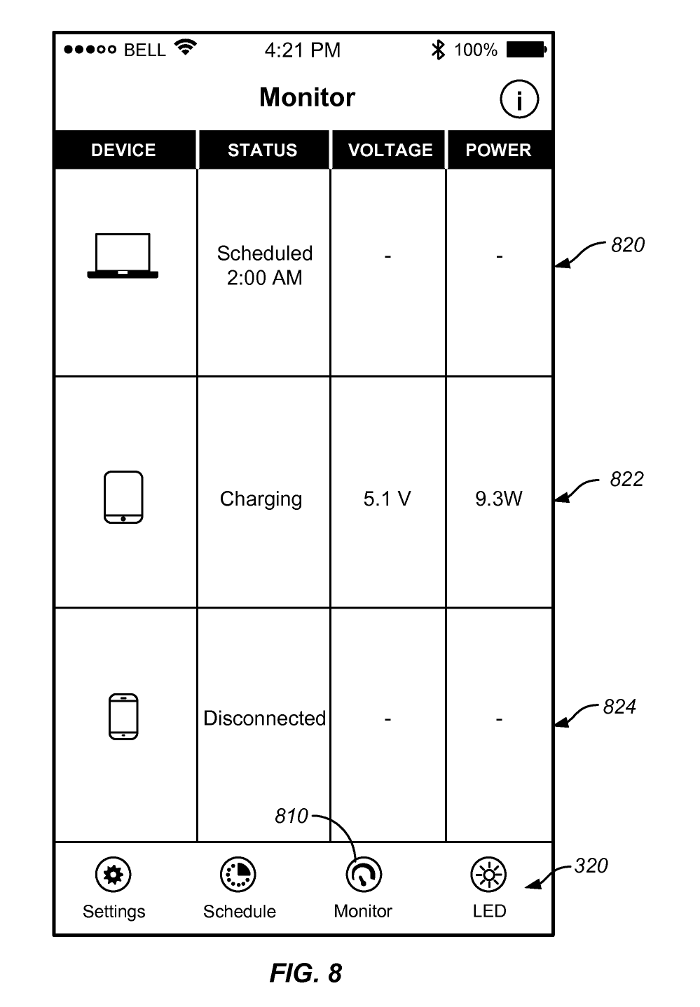

It should be noted that an association can be made between devices and output ports by the power adapter. Although output port 214A is typically associated with a laptop computer and output ports 214B and 214C are associated with a tablet and a smartphone, respectively, this is not required by the present invention. In some embodiments, information related to a particular device is stored by the memory of the power adapter and when that particular device is plugged into a given output port, the power adapter recognizes the particular device and then uses the device information in the various graphical user interfaces described herein. Referring to FIG. 8 below, the device column includes an icon for each of the three devices. Using the association between the output ports and the devices, the Monitor screen is able to show the status of the various devices, for example, that the smartphone is disconnected, independent of the actual output port to which the smartphone is connected.

It should be noted that in some implementations, the order in which device characteristics are defined (FIG. 3) and power/charging priorities are set (FIG. 4) are varied, with device characteristics being defined before or after setting of charging priorities. In other implementations, the default settings can be utilized, enabling the user to start using the power adapter and then modify the performance characteristics of the power adapter after the initial use.

FIG. 5A is a simplified graphical user interface after setting charging priority according to an embodiment of the present invention. In FIG. 5A, the priority with which the various devices will be charged is shown for the user, including information on the various devices, which can include manufacturer and model number, information that is specific to the particular electronic device, such as which charging tip to use with a particular laptop, nicknames for the devices, and the like. Utilizing the interface illustrated in FIG. 5A, the user can utilize the mobile application to implement prioritization of devices that enables the user to effectively program the adapter with the identity of the device that is the most important to charge, the second most important to charge, and so on, to the device that is the least important to charge. In some embodiments, the power adapter will attempt to charge all connected devices. If the total amount of power needed to charge all the devices exceeds the power rating of the power adapter, which can be indicated by an increase in operating temperature, current exceeding a current limit at a predetermined voltage, output power exceeding the power adapter's power limit, or the like, the power adapter will start reducing the amount of power available for charging by throttling back the charging process of the lowest priority device. If additional load shedding is appropriate, the device with the next highest priority, and so on, is throttled back until the power adapter is operating at the desired power level. Herein, embodiments are included that can utilize reducing current, reducing voltage, average values of current and/or voltage, or combinations thereof to reduce output power.

Embodiments of the present invention enable a user to plug devices into all of the available output ports, even if the sum of the charging powers for the devices exceeds the power rating of the power adapter. Using the prioritization process described herein, although all devices are plugged in, the power delivered to each of the output ports will be managed by the power adapter to charge the devices without overloading the capabilities of the power adapter. As an example, if a three output power adapter has a power rating of 80 W, a user may plug in a laptop that consumes 65 W using the first output port, a first tablet that consumes 12 W using the second output port, and a second tablet that consumes 12 W using the third output port. Since the sum of the power consumptions is 89 W and exceeds the 80 W power rating of the power adapter, the prioritization process will reduce the power delivered to one or more of the devices to operate at a power output of less than or equal to 80 W.

Thus, embodiments of the present invention provide a user experience in which the user can plug devices into all available output ports and all the devices will be charged, but at different rates depending on their priority. In some embodiments, the priority is set by the user through the mobile application. In other embodiments, the priority for charging is set by default, with the first output port (a high power port suitable for a laptop) as the highest priority, the second output port (suitable for a tablet or phone) as the next highest priority, and so on through the last output port.

In an exemplary use case, the user plugs two or more devices into the power adapter and all devices start charging. If one or more parameters associated with the power adapter begin to exceed predetermined thresholds, which can be referred to as a setpoints, then the power adapter output power is reduced by reducing the output power of one or more of the output ports in one of several manners.

In order to reduce the power provided to one or more of the output ports, an output port can have the output power reduced to zero or the reduced power output ports can be operated in a pulse width modulation (PWM) mode in some embodiments. Operation in the PWM mode enables several charging scenarios when the combined power consumption of the connected devices exceeds the power rating of the power adapter.

A first mode of PWM operation reduces the duty cycle of the power delivered to the lowest priority device. In the above example, the duty cycle of the power delivered to the second tablet is decreased from 100% to 25%, producing an average power of 3 W for the second tablet. Thus, the second tablet would be charged at a rate four times slower than the first tablet. This reduction in the duty cycle of the third output port provides an operating power level of 80 W (65 W+12 W+3 W) for the power adapter. Repetition rates for PWM cycles are in the hertz range (e.g., 0.1-1 Hz) for some implementation. Thus, this first mode of PWM operation provides a mechanism for reducing average power consumption by reducing the duty cycle of the output voltage or current, i.e., reducing the average voltage and/or current.

A second mode of PWM operation maintains the average power of the power adapter at a predetermined power level (e.g., 80 W in this example) by operating for a first time period at a power level that exceeds the power rating of the power adapter (i.e., charging all three devices for the first time period, such as a number of seconds, thereby operating at 89 W in the above example) and then operating for a second time period at a power level that is less than the power rating of the power adapter. In this second mode, following along with the above example, the power adapter would charge the second tablet using the third output port for a first time period (e.g., 3 seconds) and then set the third output port to 0 V for a second time period (e.g., 9 seconds). The average power of the power adapter will be (89 W×¼)+(77 W ¾)=80 W. In a manner similar to the first PWM mode, the second tablet is charged at a rate four times slower than the first tablet.

In the PWM modes, the limits can be values other than zero and 100% of the rated power. Some embodiments utilize limits of zero and 100%. Other embodiments utilize a first limit greater than or equal to zero and a second limit that exceeds the rated power. One of ordinary skill in the art would recognize many variations, modifications, and alternatives.

Another mode of providing reduced output power utilizes device settings that enable the device to be charged at various rates. As an example, some devices can determine the current available from a charging port (e.g., by reading a voltage on a pin of a charging port) and then adjust their charging current accordingly. This variation in charging rate enables the device to be charged at a high rate when the power adapter is operating at less than its rated power and to be charged at a lower rate when the power adapter reduces the output power available at one of the lower priority output ports.

In an embodiment, a port emulator is integrated in the power adapter that under the control of a controller, can emulate output ports having differing charging current capabilities. For example, an output port connected to a tablet is configured to initially provide an output power of 12 W. The tablet senses the 12 W configuration, typically by reading a voltage on a voltage divider integrated with the output port, and initially draws 12 W of power during charging. In order to reduce the power provided at the output port, the port emulator modifies the configuration of the output port (e.g., by modifying the voltage of the voltage divider) to provide an output power of 5 W. When the tablet in this example senses the modified configuration, the device reduces its charge consumption to consume 5 W in accordance with the 5 W output power of the port.

In other implementations, a command is sent to the device (either through the wired connection or wirelessly) to provide modified configuration information for the output port, thereby reducing the charge consumption by the device to effect the desired power reduction for the output port. Thus, embodiments provide the ability to reduce power output for a port based on decreased power output by the port, decreased power consumption by the device, combinations thereof, or the like. One of ordinary skill in the art would recognize many variations, modifications, and alternatives.

In addition to these modes of managing power consumption, other modes are included within the scope of the present invention, including hardware-based solutions, software-based solutions incorporating communication between the device and the power adapter related to the power available on a given port, and the like.

The graphical user interface utilizes a charging priorities table that includes information on the charging priority for the various electronic devices (e.g., High, Medium, and Low) as well as a graphical representation of the various electronic devices (Laptop icon 510 Tablet icon 512, and smartphone icon 514). Nicknames or other identifiers for the various electronic devices (e.g., Laptop, Tablet, iPhone) are displayed adjacent the graphical representations of the various electronic devices. In some embodiments, either a graphical representation or an identifier is utilized rather than the combination illustrated in FIG. 5A. Additionally, the graphical user interface can include information on the various devices, such as manufacturer and model number, as well as other pertinent information (e.g., the tip that is associated with a particular laptop).

In FIG. 5A, the charging priorities table is laid out with the charging priorities in a first column and the devices in a second column, but this is not required by the present invention. Although the charging priority (e.g., High) and the electronic device information, including the reference to the electronic device, are illustrated in a single row, this is merely exemplary and other layouts are included within the scope of the present invention.

In some embodiments, multiple devices may be assigned a single priority. For example, two devices may be assigned high priority and one device can be assigned low priority, with no medium priority assignment. In this case, if the power consumption of the two high priority devices exceed the power rating, both of these high priority devices can be charged at a less than maximum rate using the PWM mode or the like. Extension of this situation to a case in which all devices are high priority would result in all devices charging at less than maximum rates. One of ordinary skill in the art would recognize many variations, modifications, and alternatives.

In contrast with conventional power adapters having multiple outlets (e.g., identical outlets), embodiments of the present invention enable the prioritized charging of multiple electronic devices. The ability to program the power adapter through the mobile application thus enables a user to set and modify the charging priorities depending on the user's particular needs. In some implementations, the overall power output of the power adapter is monitored, for example, through an operating temperature or an operating current. Initially, the power adapter will attempt to charge all connected devices while monitoring the overall power output. As the power output reaches the power rating, the prioritization will be used to reduce the average output power of one or more of the output ports to achieve an overall power output within the power rating.

FIG. 5B is a simplified graphical user interface illustrating charging priority and charging thresholds according to an embodiment of the present invention. In addition to prioritizing device charging as described above, the mobile application provides a mechanism for the power adapter to provide enhanced charging profiles that include charging thresholds for the various devices. As illustrated in FIG. 5B, a charging threshold column has been added to the graphical user interface, enabling the user to set the charging threshold for one or more of the devices. In comparison with FIG. 5A, where the charging thresholds are effectively set at 100% for each of the devices, the charging thresholds can be set using the graphical user interface illustrated in FIG. 5A such that once the charging threshold is reached, devices with lower priority can be charged and then higher priority devices can be charged to a higher charging threshold at a later time.

In FIG. 5B, the charging threshold for the laptop has been set to 50%, the tablet to 75%, and the phone to 100%. By defining both priority and charging thresholds, the user is able to control charging processes in a manner not available using conventional techniques. As an example, if the user has a limited time to charge all of their devices, the user can specify that they want the laptop be 50% charged, the tablet to be 75% charged, and the phone to be fully charged. In terms of priority, the user wants to ensure that the laptop is 50% charged, for example, before the user moves to a location without charging capabilities. As described herein, embodiments provide a dynamic charging priority that varies charging priority based on charging thresholds.

In an exemplary use case, initially, all three devices will be charged by the power adapter. When the power adapter reduces output power, the phone will either stop being charged, or charged at a lower rate than the other devices. Once the laptop, which is receiving highest priority charging, reaches the 50% charging threshold, the charging priorities will be modified such that the laptop stops charging and the phone initiates or resumes full charging until the phone is 100% charged. Once the phone is fully charged, charging of the laptop toward a full charge can resume. Thus, in this embodiment, the priority can be dynamically overridden by the charging thresholds once the charging thresholds for higher priority devices are achieved. In a similar manner, if the charging rate of the tablet had been stopped or lowered, once the laptop reached the desired charging threshold, the tablet would be charged to 75%. Once all devices have reached the desired charging threshold, charging priority reverts to the priorities defined by the settings.

In some embodiments, device scheduling can be integrated with the illustrated priority and charging thresholds, providing the user with feedback that not all goals can be accomplished in a given time. Such feedback can then be used by the user to reprioritize the devices, modify the charging thresholds, modify the scheduled charging times, combinations thereof, or the like.

Because electricity rates vary as a function of time during the day/night, along with other reasons, the mobile application provides a user with the ability to schedule charging for specific times. Using a conventional power adapter, charging begins when a device is plugged into the adapter. However, a user who plugs in a laptop during peak hours (e.g., 6 p.m.) may want to delay the beginning of the charging process until electric rates have dropped (e.g., until after midnight and before 6 a.m.). Thus, embodiments provide the user with the ability to schedule the charging processes for the various devices connected to the power adapter. In some embodiments, the charging processes can be synchronized with times at which electric rates change. The timing can be provided by an external device, such as a device plugged into the power adapter (e.g., the power adapter can obtain the current time from a phone during the scheduling process) or by an internal clock in the power adapter.

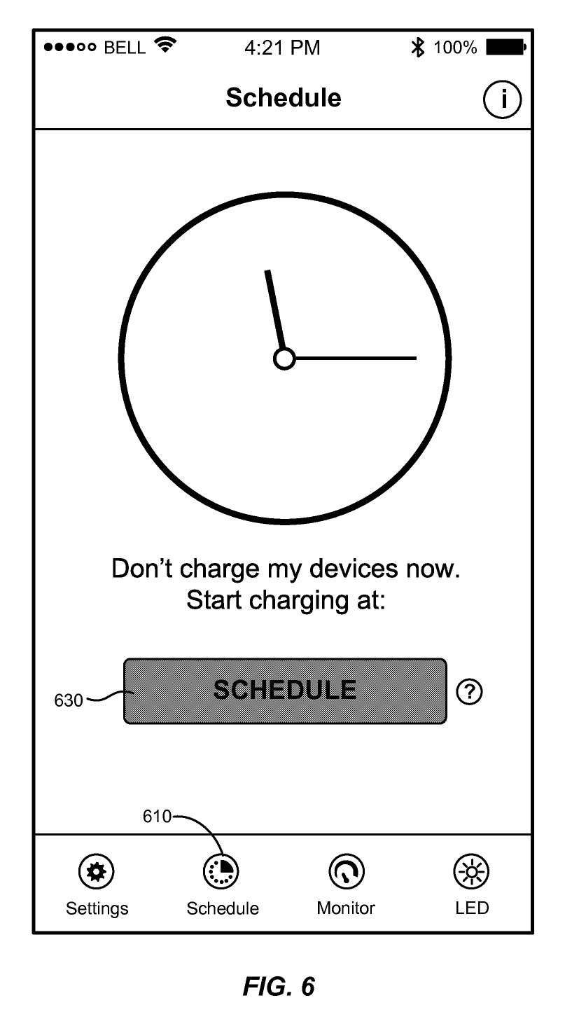

FIG. 6 is a simplified graphical user interface illustrating scheduling of charging according to an embodiment of the present invention. As illustrated in FIG. 6, a Schedule icon 610 is selected to access the scheduling functions provided by the mobile application. The scheduling functions enable a user to select between starting charging immediately when the electronic devices are plugged into the power adapter, or to schedule charging for a specific time in the future. The period during which charging can be scheduled can be selected by default (e.g., during the next 12 hours) or can be set by the user.

In some embodiments, the estimated charging time for a device can be utilized as part of the scheduling process. For example, if a laptop is plugged in and the user attempts to schedule the laptop for a 4 a.m. start time, the laptop can provide an estimated charging time (e.g., 3 hours) to the power adapter. This information could be used to provide the user with a notification that the charging will not be complete until 7 a.m., which may result in the user shifting the scheduled start time back to an earlier start time (e.g., 2 a.m.) in order to have the charging completed by a desired time at which all devices should be charged (e.g., 6 a.m.), which can be a default time or a time defined by the user. Thus, feedback from the device connected to the power adapter could be utilized during the scheduling process. As an example, the user could define a time at which the device is to be charged. Using feedback from the device, the power adapter can then compute the appropriate start time. One of ordinary skill in the art would recognize many variations, modifications, and alternatives.

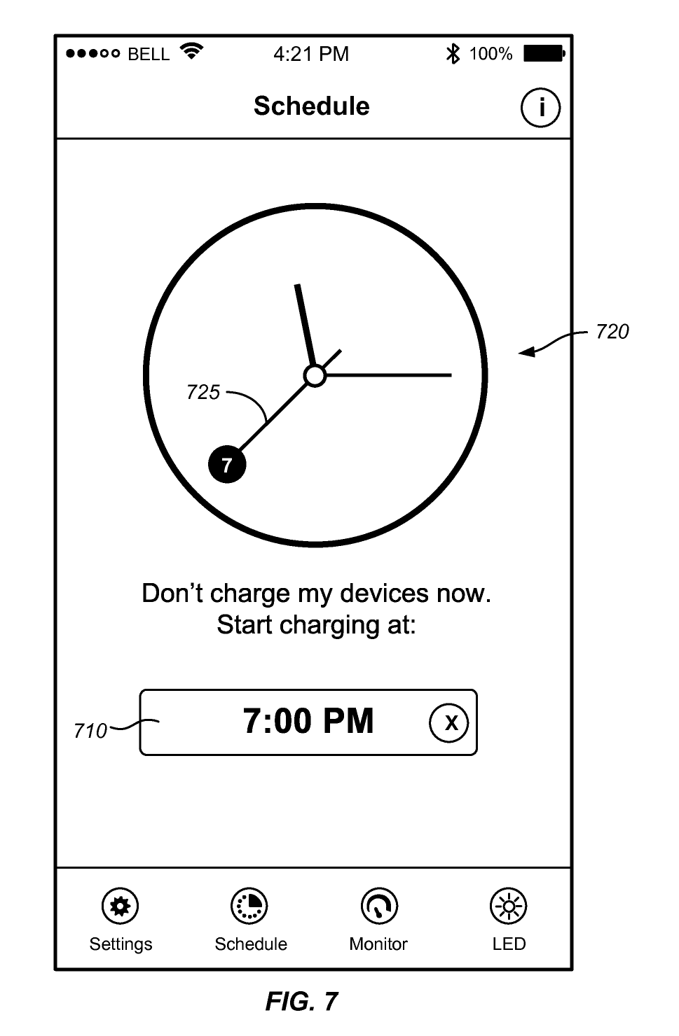

FIG. 7 is a simplified graphical user interface illustrating scheduling charge start time according to an embodiment of the present invention. The user initiates the process of scheduling the charging time by selecting the schedule button 630 illustrated in FIG. 6. The selection of the schedule button will cause the button to display a time window 710, which can display a default time (e.g., 7:00 PM in the illustrated example). The time window can provide a drop down menu that enables the user to set the start time for the charging operation. In some embodiments, a clock 720 is displayed to show the current time as well as a hand 725 indicating the time at which charging will begin.

The scheduling capability provides the user with the ability to time-prioritize the charging processes. Thus, in addition to prioritization of charging power, the user can determine which devices should be charged first and which devices can be charged later, providing a flexibility and control that is not available using conventional systems.

FIG. 8 is a simplified graphical user interface illustrating monitoring of device charging according to an embodiment of the present invention. The monitoring functions of the mobile application are accessed through selection of the Monitor icon 810 in the icon tray 320. In the Monitor graphical user interface, the mobile application displays current (e.g., instantaneous) values associated with the status and electrical characteristics of the electronic devices that can be connected to the output ports of the power adapter. Referring to FIG. 8, voltage and power consumption for each of the three outputs of the power adapter are shown in association with the device associated with the particular output. The data in the Monitor graphical user interface is updated on a regular or aperiodic basis, for example, every second, or the like. In addition to the illustrated electrical characteristics, other performance parameters can be monitored, including power adapter temperature (e.g., internal temperature, temperature of one or more components), output current, status of different protections, mode of operation (e.g., PWM), or the like.

As illustrated in FIG. 8, the laptop in row 820 is scheduled for charging at 2:00 AM. Accordingly, the voltage and power consumption for the output port associated with the laptop is zero. The tablet in row 822 is currently charging, with 5.1 V being provided at the output port, resulting in a power output at the output port and a corresponding consumption by the tablet of 9.3 W. The phone in row 824 is currently disconnected and not drawing any power from the power adapter.

In addition to the device information illustrated in FIG. 8, the mobile application can provide the user with information on the status of the power adapter, including a display of the current (e.g., instantaneous) value of the internal power adapter temperature. This temperate data can be updated periodically or aperiodically, for example, every second, every minute, or the like. The display can be in the form of a temperature, a bar graph indicating the temperature, or the like. In case over-temperature protection is triggered for the power adapter, the mobile application will display a notification to the user related to the over-temperature protection, for example, that the adapter has temporarily shut down to prevent overheating and will restart momentarily, that one or more of the output ports has been turned off, that the power being output at one or more of the output ports will be throttled back and the charging time will be increasing, or the like. The information on the temperature of the power adapter enables the user to reprioritize their charging schedule, balance the charging percentages, or the like.

It should be noted that although the monitoring function discussed in relation to FIG. 8 illustrates multiple devices operating in conjunction with a multiple output port power adapter, some embodiments of the present invention are applicable in the context of a single output power adapter as discussed in U.S. patent application Ser. No. 14/301,046. As an example, scheduling and monitoring functionality can be implemented for a single device powered or charged using a single output power adapter.

As an example, embodiments can include a method of monitoring of charging process. The method includes establishing a communications channel between a control device and a power adapter having an output port. The method also includes defining a relationship between an electronic device and the output port and displaying, in a graphical user interface, a status of the electronic device. The status can include a power output level of the output port or a power consumption level of the electronic device.

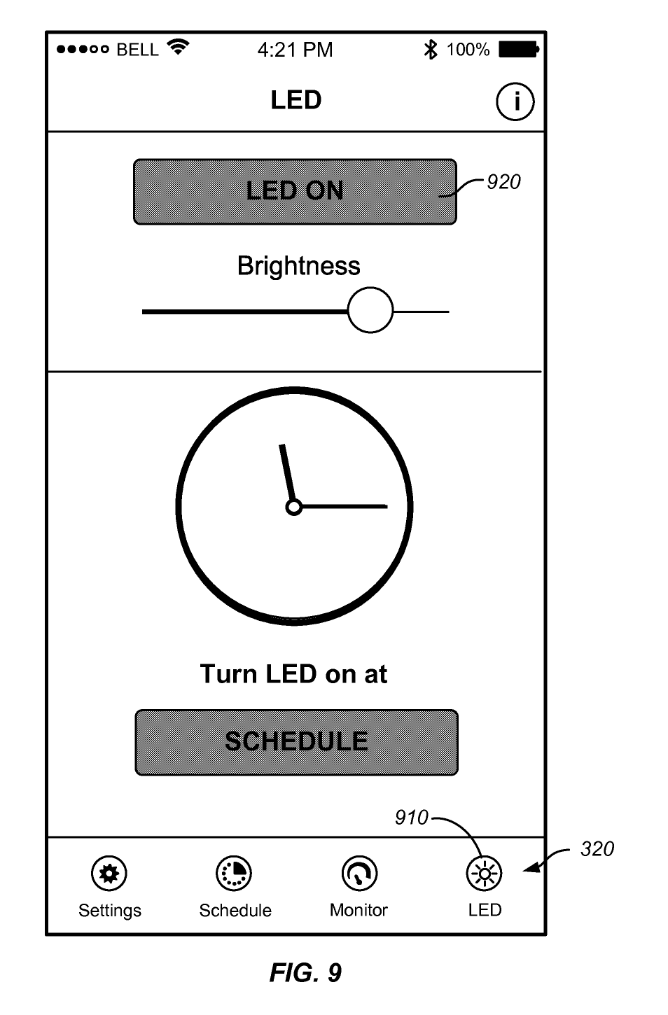

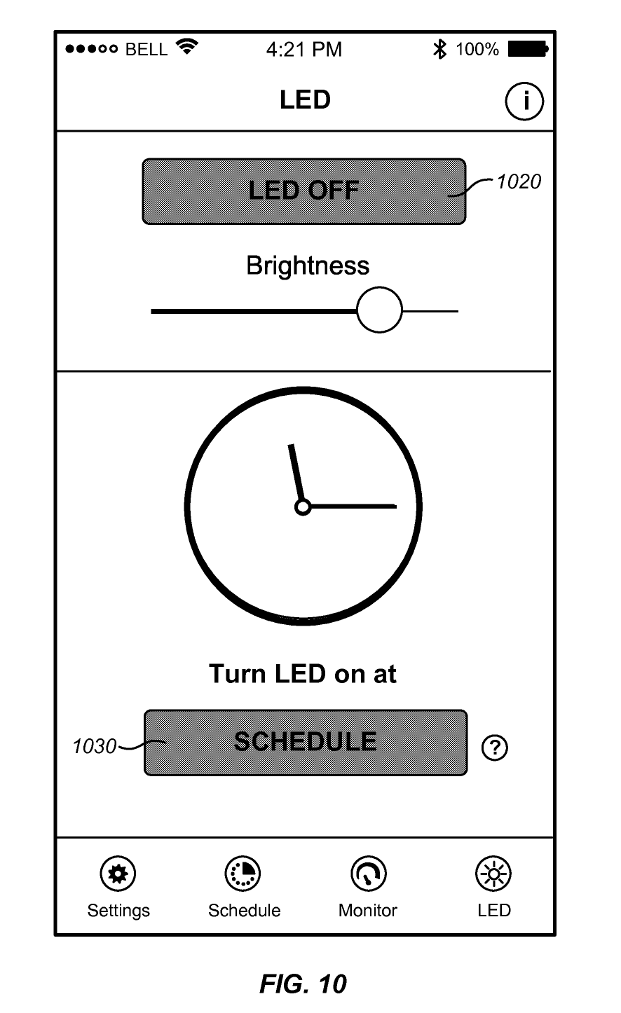

FIG. 9 is a simplified graphical user interface illustrating LED operation according to an embodiment of the present invention. The LED functions of the mobile application are accessed through selection of the LED icon 910 in the icon tray 320. The LED graphical user interface as illustrated in FIG. 9 enables a user to modify the brightness of the LED 250. In the LED graphical user interface, the current status of the LED as on (LED ON indicator 920 in FIG. 9) or off (LED OFF indicator 1020 in FIG. 10) is indicated. Thus, the mobile application displays the status of the LED (ON or OFF).

FIG. 10 is a simplified graphical user interface illustrating scheduling of LED operation according to an embodiment of the present invention. Using the LED graphical user interface, the user is provided with the ability to turn the LED ON/OFF with integrated controls or to schedule the LED turn ON/OFF at specific times, for example, during a predetermined period such as the next 12 hours. Referring to FIG. 10, the user initiates the process of scheduling the LED ON/OFF time by selecting the schedule button 1030 illustrated in FIG. 10. The mobile application enables a user to turn the LED on, either at a predetermined time, or to synchronize the LED with the phone's alarm, so that when the alarm goes off, the LED turns on, or the like.

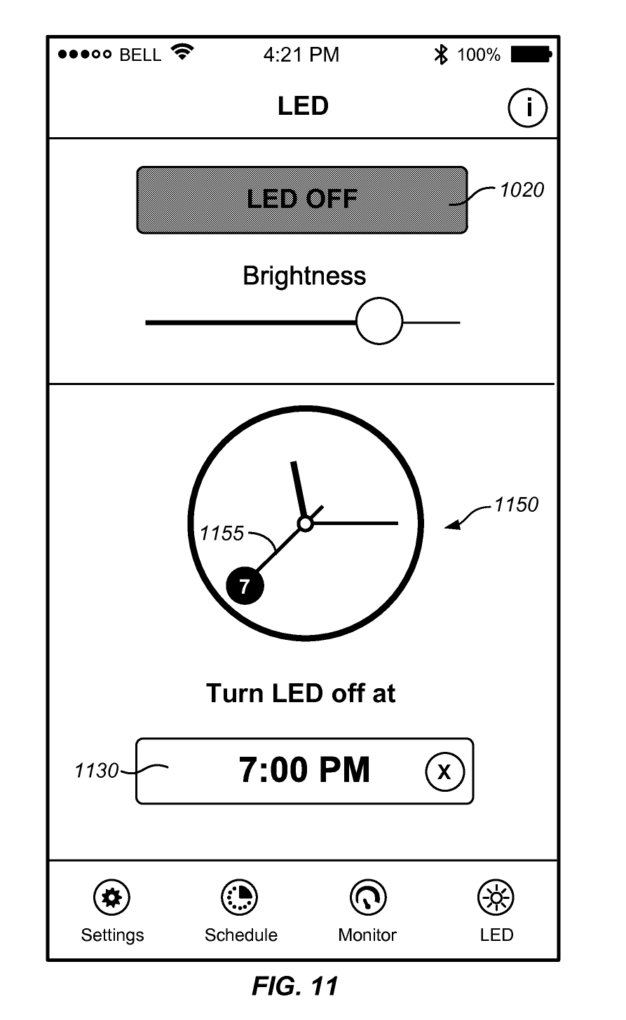

FIG. 11 is a simplified graphical user interface illustrating scheduling of LED extinguishing according to an embodiment of the present invention. The selection of the LED off button 1020 will cause a time window 1130 to be displayed. The time window 1130 can display a default time (e.g., 7:00 PM in the illustrated example). The time window can provide a drop down menu that enables the user to set the time at which the LED will be turned on and/or turned off. In some embodiments, a clock 1150 is displayed to show the current time as well as a hand 1155 indicating the time (e.g., 7:00 PM) at which the LED will turn off.

In addition to control of the LED light through the mobile application, embodiments of the present invention enable a user to synchronize the LED turn on time with a smartphone's alarm.

In addition to the user-side graphical user interfaces illustrated herein, the mobile application has an engineering monitoring (EM) mode. In the EM mode, a service technician is able to send commands and read values of the various registers of the power adapter. The EM mode is useful for engineering and manufacturing personnel and service providers to perform troubleshooting and monitoring of the power adapter. The EM mode is typically inaccessible by default, with login or other unlocking features utilized to enable the service technician to access the EM mode.

Moreover, user support functions are provided by the mobile application. For example, the mobile application can provide access to a User Manual for the specific power adapter model that was identified by the mobile application. The User Manual can be stored on a remote server or inside the mobile application depending on the implementation. Moreover, the mobile application can provide a portal to facilitate purchases of additional power adapters, accessories that are compatible with the specific power adapter model that was identified by the mobile application, and the like.

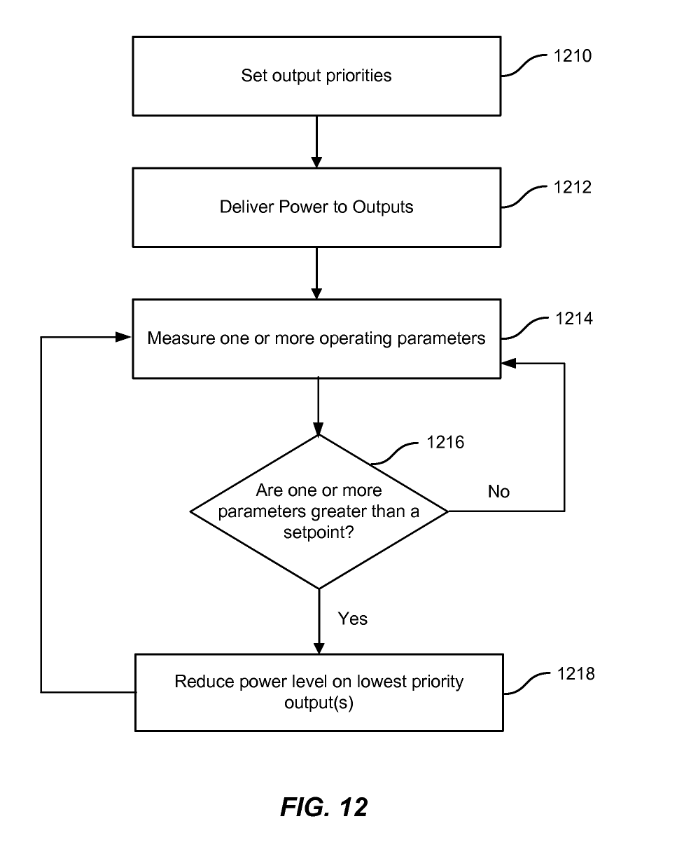

FIG. 12 is a simplified flowchart illustrating a method of operating a power adapter having multiple outputs according to an embodiment of the present invention. As described herein, a first output port of the multiple output ports can be rated at a first output power level and a second output port of the multiple output ports can be rated at a second output power level less than the first output power level, providing ports that are appropriate for powering/charging of a laptop at a higher power level and powering/charging of a tablet at a lower power level.

The method includes setting an output priority for each of the multiple outputs (1210) and providing an output power at each of the multiple outputs (1212). Additional description related setting the output priorities is provided in relation to FIG. 4 discussed above. By moving the tiles associated with the devices up or down, the priority associated with each device can be modified to various levels such as the High, Medium, and Low priorities illustrated in FIG. 4.

The method also includes measuring one or more operating parameters of the power adapter (1214) and determining if at least one of the one or more operating parameters are greater than a setpoint (1216). The monitoring process illustrated in FIG. 8 can work in conjunction with the measuring process illustrated in FIG. 12.

If the one or more operating parameters are not greater than a setpoint, then the method returns to the measurement process at 1214. If, however, the one or more operating parameters are greater than the setpoint, then the method includes reducing the output power associated with at least one of the multiple output ports (1218). After reducing the output power, the method returns to the measurement process at 1214. Reductions in the output power can include performing a PWM process at the at least one of the multiple output ports. Alternatively, the power consumed by the lower priority device can be reduced by the device in response to a command or other modification provided by the power adapter.

When the one or more operating parameters are again greater than the setpoint, the power level is reduced on the next lowest priority output (1218). In this method, multiple devices are concurrently charged until a setpoint (e.g., output power or temperature of the power adapter) is reached. The power available to the lowest priority device is then reduced. If additional power reduction is needed, then the next lowest priority device is provided with reduced or no power.

It should be noted that although not illustrated in FIG. 12, if the parameter that resulted in power reduction returns to a level less than the setpoint, then the lower priority devices can be added back in by restoring some or all of the initial power at the output ports associated with the lower priority devices. One of ordinary skill in the art would recognize many variations, modifications, and alternatives.

It should be appreciated that the specific steps illustrated in FIG. 12 provide a particular method of setting charging priority according to an embodiment of the present invention. Other sequences of steps may also be performed according to alternative embodiments. For example, alternative embodiments of the present invention may perform the steps outlined above in a different order. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize many variations, modifications, and alternatives.

Although embodiments in FIGS. 3-11 are illustrated in portrait mode, landscape mode is included within the scope of the present invention and the present invention is not limited to the use of portrait mode.

It is also understood that the examples and embodiments described herein are for illustrative purposes only and that various modifications or changes in light thereof will be suggested to persons skilled in the art and are to be included within the spirit and purview of this application and scope of the appended claims.

1. A method of prioritizing powering processes, the method comprising:
establishing a communications channel between a control device and a power adapter having a power rating and a plurality of output ports, wherein a first output port of the plurality of output ports has a first maximum power level and is operable to power a first electronic device and a second output port of the plurality of output ports has a second maximum power level and is operable to power a second electronic device;
presenting, to a user, a list of electronic devices including the first electronic device and the second electronic device;
defining a prioritization for powering of the first electronic device and the second electronic device, wherein the prioritization ranks the first electronic device higher than the second electronic device;
providing a first output power at the first output port operable to power the first electronic device;
determining that concurrent powering of the second electronic device will exceed the power rating of the power adapter; and
providing a second output power at the second output port less than the second maximum power level.

2. The method of claim 1 further comprising providing an initial output power at the second output port equal to the second maximum power level prior to determining that the concurrent powering of the second electronic device will exceed the power rating of the power adapter.

3. The method of claim 1 wherein the communications channel comprises a wired connection.

4. The method of claim 1 wherein the communications channel comprises a wireless connection.

5. The method of claim 1 wherein the control device comprises a smartphone.

6. The method of claim 1 wherein the control device comprises at least one of a tablet, a portable computer, or a desktop computer.

7. The method of claim 1 wherein the first electronic device comprises at least one of a portable computer, a tablet, or a smartphone.

8. The method of claim 1 wherein defining the prioritization of powering comprises receiving, from the user, the prioritization of powering.

9. The method of claim 1 wherein the second output voltage is 0 V.

10. The method of claim 1 wherein the second output power varies in accordance with a PWM process.

11. A method of monitoring one or more charging processes, the method comprising:
establishing a communications channel between a control device and a power adapter having a first output port;
defining a relationship between a first electronic device and the first output port; and
displaying, in a graphical user interface, a status of the first electronic device.

12. The method of claim 11 wherein the status of the first electronic device includes a power output level of the first output port.

13. The method of claim 11 wherein the power adapter includes multiple output ports, the method further comprising:
defining a relationship between a second electronic device and a second output port of the power adapter; and
displaying, in the graphical user interface, a status of the second electronic device, wherein the status of the second electronic device includes a power output level of the second output port.

14. The method of claim 13 wherein the first output port is characterized by a maximum output power greater than a maximum output power of the second output port.

15. The method of claim 11 wherein the graphical user interface comprises a pane of a mobile application.

16. The method of claim 11 further comprising updating, in the graphical user interface after a predetermined time, the power output level of the second output port.

17. A method of displaying charging priorities for a plurality of electronic devices, the method comprising:
establishing a communications channel between a control device and a power adapter having multiple output ports;
associating a first priority with a first electronic device having a first charging profile;
associating a second priority with a second electronic device having a second charging profile; and
displaying, in a graphical user interface, a charging priorities table including the first priority, a reference to the first electronic device, the second priority, and a reference to the second electronic device.

18. The method of claim 17 further comprising:
assigning the first electronic device to a first output port of the power adapter; and
assigning the second electronic device to a second output port of the power adapter.

19. The method of claim 17 wherein the communications channel is associated with a wired connection.

20. The method of claim 17 wherein the first charging profile is characterized by a first power level and the second charging profile is characterized by a second power level less than the first power level.

21. The method of claim 17 wherein the reference to the first electronic device comprises a graphical representation of the first electronic device

22. The method of claim 17 wherein the first priority and the reference to the first electronic device are adjacent each other in the charging priorities table.

23. The method of claim 17 further comprising:
selecting the second electronic device;
associating the first priority with the second electronic device;
associating the second priority with the first electronic device; and
updating, in the graphical user interface, the charging priorities table.

24. A method of displaying charging thresholds for a plurality of electronic devices, the method comprising:
establishing a communications channel between a control device and a power adapter having multiple output ports;
defining a first charging threshold for a first electronic device having a first charging priority;
defining a second charging threshold for a second electronic device having a second charging priority;
displaying, in a graphical user interface, a charging priorities table including:
the first charging priority, a reference to the first electronic device, and the first charging threshold; and
the second charging priority, a reference to the second electronic device, and the second charging threshold; and
charging the first electronic device at a first charging rate.

25. The method of claim 24 further comprising:
determining that the first charging threshold has been met;
reducing the charging rate of the first electronic device; and
charging the second electronic device.

26. The method of claim 25 wherein reducing the charging rate of the first electronic device comprises stopping charging of the first electronic device.

27. The method of claim 25 further comprising:
determining that the second charging threshold has been met;
reducing the charging rate of the second electronic device; and
resuming charging of the first electronic device.

28. The method of claim 24 further comprising associating the first charging priority with the first electronic device and associating the second charging priority with the second electronic device.

29. The method of claim 24 further comprising:
assigning the first electronic device to a first output port of the power adapter; and
assigning the second electronic device to a second output port of the power adapter.

30. The method of claim 24 wherein the reference to the first electronic device comprises a graphical representation of the first electronic device

31. The method of claim 24 wherein the reference to the first electronic device, the first charging priority, and the first charging threshold are adjacent each other in the charging priorities table.

32. A method of operating a power adapter having multiple outputs, the method comprising:
setting an output priority for each of the multiple outputs;
providing an output voltage at each of the multiple outputs;
measuring one or more operating parameters of the power adapter;
determining that at least one of the one or more operating parameters are greater than a setpoint; and
reducing the output voltage associated with at least one of the multiple output ports.

33. The method of claim 32 wherein the one or more operating parameters include at least one of output power or temperature associated with the power adapter.

34. The method of claim 32 wherein:
a first output port of the multiple output ports is rated at a first output power level; and
a second output port of the multiple output ports is rated at a second output power level less than the first output power level.

35. The method of claim 32 wherein reducing the output voltage comprises performing a PWM process at the at least one of the multiple output ports.
